(19) United States
(12) Patent Application Publication
(10) Pub. No.: US 2026/0070000 A1
(43) Pub. Date: Mar. 12, 2026

(54) DISCONTINUOUSLY OPERATED DESUBLIMATOR HAVING AT LEAST ONE FLOW DISRUPTOR

(71) Applicant: BASF SE, Ludwigshafen am Rhein (DE)

(72) Inventors: Gregor GRACKIEWICZ, Ludwigshafen am Rhein (DE); Marek PAZICKY, Ludwigshafen am Rhein (DE); Florian SCHARF, Ludwigshafen am Rhein (DE); Clemens Thomas CHAN-BRAUN, Ludwigshafen am Rhein (DE); Christian HUF, Ludwigshafen am Rhein (DE); Sebastian Tobias UPPENKAMP, Ludwigshafen am Rhein (DE)

(21) Appl. No.: 19/108,464

(22) PCT Filed: Aug. 30, 2023
(86) PCT No.: PCT/EP2023/073820

§ 371 Date: Mar. 4, 2025

(30) Foreign Application Priority Data
Sep. 6, 2022 (EP) 22194158.6

(51) Int. Cl. B01D 7/02

(52) U.S. Cl. CPC B01D 7/02

(57) ABSTRACT

The invention relates to a discontinuously operated desublimator (1) for removing at least one gas component to be desublimated from a gas mixture flow, which desublimator comprises: a housing wall (7); an inlet (2) in the housing wall (7) for supplying the gas mixture flow into the desublimator (1); an outlet (6) in the housing wall (7) for discharging the treated gas mixture flow from the desublimator (1); a desublimation zone (4) with temperature-controllable flow channel walls, wherein the flow channel walls are temperature-controllable in such a way that during a loading process the at least one gas component to be desublimated is desublimated at the flow channel walls and that during a subsequent melting process the at least one gas component desublimated in the loading process melts at the flow channel walls; a gas entry distribution chamber (3), which is located between the inlet (2) and the desublimation zone (4); and a gas exit distribution chamber (5), which is located between the outlet (6) and the desublimation zone (4). According to the invention, a flow disruptor (8) is located in the gas entry distribution chamber (3) for uniformly distributing the gas mixture flow through the flow channels that result from the flow channel walls of the desublimation zone (4), the geometric centre of gravity of which flow disruption has a spacing (AT) from the geometric centre of gravity of the inlet surface (9) in the range of 0.2*D to 10.0*D, preferably in the range of 0.5*D to 3.0*D, wherein D corresponds to the equivalent diameter of a circle having the same area as the inlet surface (9) and the spacing (AT) is measured along the normal vector (nE) of the inlet surface (9). The invention also relates to a method for operating a desublimator (1) according to the invention.

The invention relates to a discontinuously operated desublimer for removing at least one gas component to be desublimed from a gas mixture flow, comprising a housing wall, an inlet in the housing wall for supply of the gas mixture flow, an outlet in the housing wall for removal of the treated gas mixture flow, and
a desublimation zone with temperature-controllable flow channel walls,
where the temperature of the flow channel walls is controllable such that, during a loading process, the at least one gas component to be desublimed is desublimed at the flow channel walls, and that, during a subsequent melting process, the at least one gas component desublimed in the loading process melts at the flow channel walls.

In addition, the desublimer comprises a gas inlet distributor space between the inlet and the desublimation zone, and a gas outlet space between the outlet and the desublimation zone.

Known discontinuously operated desublimers have, in their interior, flow channel walls that may take the form of bundles of fin tubes. It is a feature of fin tubes that the tubes thereof are surrounded by fins, and the fins can be heated or cooled by a fluid that flows through the tubes. Thus, during the loading process, a gas component to be desublimed which is present in a gas or gas-vapor mixture is obtained by desubliming the gas component to be desublimed at the cooled fins. In a subsequent melting process, the gas component desublimed on the now heated walls of the fin tubes is melted and discharged from the desublimer. Rather than the fin tubes, other embodiments of flow channel walls, for example lamellas or honeycombs, may also be disposed in the desublimer. When lamellas are used, the cooling or heating medium is typically passed through fluid conduits that are generally disposed on the outside of the housing walls, such that the heat is transferred essentially between the fluid conduits on the outside and the housing wall, and between the housing wall and the lamellas.

In such above-described desublimers, the gas mixture flow during the loading process has poor uniformity of distribution with regard to flow through the flow channels, which means that the gas component to be desublimed is desublimed non-uniformly at the flow channel walls. As a result, the pressure drop between the inlet and the outlet of the desublimer increases more quickly during the loading process, and the desublimer thus has to be regenerated at shorter time intervals, even though its maximum loading capacity is yet to be attained. The desublimer here is typically regenerated by the melting process and by an optional subsequent recooling process.

DE3407104 A1 discloses discontinuously operated desublimers for the separation of products from gas mixtures, which have internal lamellas as flow channel walls, secured to the lateral housing walls. A coolant or heating medium is passed through fluid conduits disposed solely on the outside of the lateral housing walls. Heat is transferred in the case of heating of the lamellas from the fluid conduits to the lateral housing walls and from the lateral housing walls to the lamellas, whereas heat is transferred in the case of cooling of the lamellas from the lamellas to the lateral housing walls and from the lateral housing walls to the fluid conduits. These desublimers are used, for example, for production of phthalic anhydride (PA).

However, greater parasitic heat losses to the environment arise here, since the desublimer is only externally heated or cooled. In the case of larger desublimers having an internal volume of, for example, more than 1 m³, however, heat transfer between the lateral housing walls and the lamellas further removed from the lateral housing walls during the operation of the desublimer is generally too low, such that a temperature gradient within the lamellas is established during the loading process, and this leads to different rates of desublimation. As a result, there is a faster rise in the pressure drop during the loading process, and the desublimer thus has to be regenerated at shorter time intervals, even though its maximum loading capacity is yet to be attained.

DE102015101398 A1 discloses a discontinuously operated desublimer in a cylindrical design for removal of a gas component to be desublimed from a gas flow. The desublimer comprises a housing comprising an internal fluid conduit, and lamellas as flow channel walls, disposed on an inner face of the housing wall and directed inward. The lamellas here are also coolable by a coolant that flows through the inner fluid conduit or heatable by a heating medium that flows through the inner fluid conduit. However, if such desublimers have an internal volume of, for example, more than 1 m³, heat transfer from the inner fluid conduit to the sites in the lamellas that are further removed from the fluid conduit is generally too low, and so a temperature gradient is established within the lamellas, and leads to different rates of desublimation during the loading process. In the case of a longer design of such desublimers, the drawback arises that the desublimation takes place particularly at the sites in the lamellas that are close to the inlet of the gas mixture flow. As a result, the lamellas in the inlet region can rapidly become blocked, even if no desublimation should have taken place at all wall surfaces of the lamellas. As a result of the disadvantages described above, there is a faster rise in the pressure drop during the loading process, and the desublimer thus has to be regenerated at shorter time intervals, even though its maximum loading capacity is yet to be attained.

The problem addressed was therefore that of providing a desublimer that achieves maximum uniformity of distribution of gas mixture flow through the flow channels of the desublimation zone during the loading process. A further problem addressed was that of a very slow rise in the pressure drop between the inlet and the outlet of the desublimer during the process of loading the desublimer, hence allowing regeneration of the desublimer at longer time intervals. Another problem addressed was that of providing a desublimer that has a greater loading capacity for desubliming gas components with a defined maximum pressure drop between the inlet and the outlet of the desublimer or with a defined maximum loading time for the loading process.

These problems are solved according to the present invention by a discontinuously operated desublimer according to claim 1, and by a method of operating the desublimer according to claim 17. Advantageous embodiments of the desublimer are given in claims 2 to 16.

The discontinuously operated desublimer of the invention for removal of at least one gas component to be desublimed from a gas mixture flow comprises a housing wall, an inlet in the housing wall for supply of the gas mixture flow in the desublimer, an outlet in the housing wall for removal of the treated gas mixture flow from the desublimer, a desublimation zone with temperature-controllable flow channel walls, where the temperature of the flow channel walls is controllable such that, during a loading process, the at least one gas component to be desublimed is desublimed at the flow channel walls, and that, during a subsequent melting process, the at least one gas component desublimed in the loading process melts at the flow channel walls, a gas inlet distributor space between the inlet and the desublimation zone, and a gas outlet space between the outlet and the desublimation zone.

According to the invention, at least one first baffle disposed in the gas inlet distributor space for uniform distribution of the gas mixture flow through the flow channels that result from the flow channel walls in the desublimation zone has a geometric centroid with a distance from the geometric centroid of the inlet area within a range from 0.2*D to 10.0*D, preferably within a range from 0.5*D to 3.0*D, where D corresponds to the equivalent diameter of a circle of equal area to the inlet area and the distance is measured along the normal vector of the inlet area.

In a preferred embodiment, the greatest possible distance between the geometric centroid of the first baffle and the geometric centroid of the inlet area is 0.7*L, preferably 0.5*L, particularly preferably 0.3*L, where L corresponds to the length of the longitudinal axis of the gas inlet distributor space and the distance is measured along the normal vector of the inlet area. As a result, both the aforementioned range from 0.2*D to 10.0*D and the range from 0.5*D to 3.0*D specified above as preferred is limited to the greatest possible value of 0.3*L if the distance of the geometric centroid of the first baffle to the geometric centroid of the inlet area should be greater than 0.3*L, where D corresponds to the equivalent diameter of a circle of area equal to the inlet area and L corresponds to the length of the longitudinal axis of the gas inlet distributor space, and where the distance is measured along the normal vector of the inlet area.

The first baffle or further baffles in the gas inlet distributor space, during the loading process, distribute(s) the incoming gas mixture flow more uniformly through the individual flow channels of the desublimation zone, as a result of which desublimation takes place more uniformly at the flow channel walls. The more uniform flow through the flow channels and the more uniform desublimation at the flow channel walls avoids excessive gas mixture flow velocities, some of which are far more than twice the average velocity of the gas mixture flow through the desublimation zone. In addition, interaction between the flow channel walls and the gas mixture flow is enhanced.

The desublimation of the at least one gas component to be desublimed results in coverage of the surfaces of the flow channel walls, as a result of which there is a corresponding rise in the pressure drop across the individual flow channels during the loading process. The more uniform flow through the flow channels and the more uniform desublimation at the flow channel walls have the effect that there is less of a rise in the pressure drop across the individual flow channels. There is thus less of a rise in the pressure drop between the inlet and the outlet of the desublimer of the invention even during the loading process, and the desublimer can consequently be regenerated at much longer time intervals. Moreover, the desublimer of the invention, by comparison with a desublimer without a baffle, given the same pressure drop between the inlet and the outlet of the desublimer, can desublime more of the at least one gas component to be desublimed at its flow channel walls, as a result of which the desublimer of the invention with at least one first baffle achieves a greater loading capacity for the same pressure drop.

In this document, the expression “gas mixture flow” is generally understood to mean a flowing gas mixture. The gas mixture may also be a gas-vapor mixture. In principle, the gas mixture may include liquid droplets or solid particles, to the extent that the desublimer is not damaged or blocked as a result.

In this document, the expression “a gas component to be desublimed” is generally understood to mean a gas component which is desublimed predominantly at flow channel walls within a desublimation zone, said flow channel walls having a lower temperature than the desublimation temperature during a loading process. Desublimation in thermodynamics refers to the process of direct conversion of a substance from the gaseous to the solid state of matter. The desublimation temperature indicates the maximum temperature at a given pressure below which a gas component changes to the solid state of matter.

In this document, the expression “fluid conduit” is understood to mean a traversable conduit through which a coolant or heating medium can flow. The fluid conduit may be disposed on the outside of the housing wall and/or within the desublimer. If one or more fluid conduits are disposed on the outside, the heat is transferred between the fluid conduit(s) and the housing wall, as a result of which the temperature of the gas mixture flow in contact with the inside of the housing wall is controllable. In addition, it is also possible here to control the temperature of the flow channel walls when the flow channel walls are thermally coupled to the inside of the housing wall. If one or more fluid conduits are disposed within the desublimer, the heat is generally transferred predominantly between the fluid conduit(s) and the flow channel walls, as a result of which the temperature of the flow channel walls is controllable.

In this document, the expression “housing wall” is generally understood to mean an outer boundary of the desublimer. The housing wall is typically also referred to in the literature as shell. The walls of the housing wall are of sufficient technical integrity. Typically, the outside of the housing wall is at least partly heated by an outer heating element. In general, the outer heating element takes the form of one or more fluid conduit(s) that are typically mounted directly on the outside of the housing wall. In this case, during the operation of the desublimer, a coolant or heating medium is typically conveyed through the fluid conduit(s) in order to be able to correspondingly control the temperature of the gas mixture flow and/or the flow channel walls. One or more inlet and outlet areas result from a respective cutout in the housing wall.

In this document, the expression “desublimation zone with temperature-controllable flow channel walls” is generally understood to mean a region in which, during a loading process, the at least one gas component to be desublimed is desublimed at the flow channel walls, and the rest of the gas mixture flow, which is also referred to as treated gas mixture flow, flows out of the desublimation zone and hence reaches the gas outlet space. In a melting process downstream of the loading process, the flow channel walls of the desublimation zone are heated in order to melt the gas component(s) desublimed at the flow channel walls and to conduct them out of the desublimer.

The temperature-controllable flow channel walls of the desublimation zone may be defined, by way of example, by the outer walls of fin tubes, fin tube bundles, tube bundles, lamellar bodies, honeycomb bodies, lengths of pipe, bundles of lengths of pipe, or plate bodies. Lamellar bodies, plate bodies or honeycomb bodies are understood to mean internals that correspondingly comprise lamellas, plates or honeycombs. If a lamellar body is used, the cavities present between the individual lamellas form the flow channels. Correspondingly, the flow channel walls are defined by the lamella surfaces. If the flow channel walls are defined by fin tubes, the respectively adjacent fins form a cavity that serves as flow channel, through which a fluid, for example a gas mixture, can flow. In general, bundles of fin tubes are disposed in the desublimation zone, as a result of which, for example, adjacent fin tubes can form further flow channels, or individual fin tubes in combination with correspondingly adjacent fin tubes can form continuous flow channels.

The flow channels may all have the same channel diameter, in that the fins of the fin tube or fin tubes are spaced equidistantly. Preferably, however, the flow channels have different channel diameters, in that the fins of the fin tube or fin tubes are spaced differently. In the case of flow through the flow channels, it may be advantageous for more uniform flow through the flow channels when the channel diameter at the inlet of the respective flow channel is larger than at the outlet of the respective flow channel. In addition, the at least one gas component to be desublimed is desublimed more uniformly at the flow channel walls over the length of the respective flow channel. The tubular form of the fin tube or fin tubes may be circular, oval or angular.

In addition, the inlet area of the desublimation zone is defined by the theoretical separation plane between the gas inlet distributor space and the desublimation zone, where the surfaces of the respective flow channel walls that are present in the separation plane are also assigned to the inlet area of the desublimation zone by way of simplification.

The outlet area of the desublimation zone is defined by the theoretical separation plane between the gas outlet distributor space and the desublimation zone, where the surfaces of the respective flow channel walls present in the separation plane are also assigned to the outlet area of the desublimation zone by way of simplification.

The ratio between the inlet area of the desublimation zone and the distance between the inlet area and outlet area of the desublimation zone should preferably be greater than 5 [m²/m], calculating the ratio using measurements made of the inlet area in square meters [m²] and the distance between the inlet area and outlet area of the desublimation zone in meters [m]. Compliance with preferred range for the ratio avoids any significant excess desublimation at flow channel walls in the region of the inlet area of the desublimation zone. This is because an increase in desublimation at a flow channel walls significantly reduces the minimum free gas passage area of the flow channel in question within a very short loading time, which would rapidly increase the pressure drop across the flow channel in question at the start of the loading process and would ultimately block the flow channel in question after a very short loading time, even if the desublimation at the flow channel wall in question should be effected essentially only in the region of the inlet area of the desublimation zone.

The more inlet area is available, the lesser the extent to which increased desublimation at the flow channel walls in the region of the inlet area of the desublimation zone can lead to a distinctly greater pressure drop or even to blockage.

In order that a desublimer can be designed in a cost-efficient and space-saving manner, the ratio between the inlet area of the desublimation zone and the distance between the inlet area and outlet area of the desublimation zone should preferably be less than 100 [m²/m], calculating the ratio using measurements made of the inlet area in square meters [m²] and the distance between the inlet area and outlet area of the desublimation zone in meters [m].

In order to control the temperature of the flow channel walls of the desublimation zone, it is possible by way of example for one or more traversable fluid conduit(s) disposed within the desublimation zone to have a heating medium or coolant flow through them, and hence for the temperature of the walls of the fluid conduit(s) to be correspondingly controlled. The transfer of heat between the flow channel walls and the traversable fluid conduit(s) results in corresponding temperature control of the flow channel walls. Additionally or alternatively, temperature control can be achieved by an outer traversable fluid conduit or by multiple outer traversable fluid conduits, disposed on the outside of the housing wall. In this case, the heat transfer between the flow channel walls of the desublimation zone and the outer traversable fluid conduit(s) results in corresponding temperature control of the flow channel walls of the desublimation zone, in which case heat transfer does of course also take place through the intervening housing wall.

If, during the loading process, a coolant flows through the inner or outer fluid conduit(s), the walls of the flow channels are cooled on account of the conduction of heat between the flow channel walls and the fluid conduit(s), such that the at least one gas component to be desublimed can be desublimed at the walls of the flow channels. If, during the melting process, a heating medium flows through the inner or outer fluid conduit(s), the walls of the flow channels are heated on account of the conduction of heat between the flow channel walls and the fluid conduit(s), such that the gas component(s) desublimed on the walls of the flow channels can melt. The heating medium or coolant used may, by way of example, in each case be a different or identical heat carrier oil, for example Diphyl DT.

In this document, the term “desublimed at the flow channel walls” is generally understood to mean a deposition process in which at least one gas component to be desublimed which is present in a gas mixture flow is cooled down to such an extent that it is desublimed and is deposited on the flow channel walls. The desublimed gas component(s) correspondingly adhere to the flow channel walls in the solid state of matter.

According to the given thermodynamic conditions, the word “desublimed” can also be understood in this document such that a change of phase in at least a fraction of the gas mixture flow from a gaseous to a liquid state of matter first takes place in the desublimation zone, and only then does a phase change from the liquid to the solid state of matter take place. The flow channel walls of the desublimation zone are correspondingly wetted at least partly by the liquid formed by the change of phase. As a result of the cooled flow channel walls, the change of phase from the liquid to the solid state of matter takes place at the flow channel walls within a very short time. In summary, in this case too, the gas component to be desublimed is desublimed at the flow channel walls of the desublimation zone and correspondingly adheres to the flow channel walls in the solid state of matter.

In this document, the expression “gas inlet distributor space” is generally understood to mean a space within the desublimer which is bounded by the housing wall of the desublimer, the inlet area of the desublimer, and the desublimation zone. During a loading process, a gas mixture flow flows through the gas inlet distributor space, and the gas mixture flow can flow in through an inlet in the desublimer. The gas inlet distributor space is joined by the desublimation zone with temperature-controllable flow channel walls, and the gas mixture flow can generally flow out of the gas inlet distributor space solely through said desublimation zone.

In this document, the expression “gas outlet space” is generally understood to mean a space which can be supplied with a gas mixture flow from its adjoining desublimation zone. This space typically additionally has an outlet through which the treated gas mixture flow can flow out of the desublimer.

In general, there is also a further outlet port with an outflow valve, which may, for example, be a sealing closure lid. During a melting process, the outflow valve is in the open state, which means that the melt produced can flow out of the desublimer. During a loading process, the outflow valve is in the closed state, which means no fluid can flow out of the outlet port. Typically, this further outlet port is at the lowest point of the gas outlet space, such that, as a result of gravity, the melt can flow to the further outlet port.

In this document, the expression “discontinuously operated desublimer” is generally understood to mean a desublimer which is generally operated discontinuously with two or three different process cycles. The first process cycle is a loading process in which the at least one gas component to be desublimed is desublimed at the flow channel walls of the desublimation zone. During the loading process, the flow channel walls are cooled. The second process cycle is a melting process in which the gas component(s) desublimed is/are melted and removed from the desublimer by heating the flow channel walls of the desublimation zone.

The third process cycle is an optional recooling process in which the flow channel walls of the desublimation zone are cooled after the desublimed gas component(s) have been removed from the desublimer. Rather than the recooling process, the cooling of the flow channel walls may also take place only on commencement of the loading process.

In this document, the expression “distance along the longitudinal axis of the flow channel walls” is generally understood to mean that the distance between two points in three-dimensional space is ascertained in such a way that, in a first computation step, a connecting vector between the two points is calculated by forming the difference between the two points. Subsequently, in a second computation step, the scalar product is formed with the already computed connecting vector and the vector that runs parallel to the longitudinal axis of the flow channel walls, and the magnitude thereof is normalized to the value of one. The magnitude of the scalar product thus calculated constitutes the distance along the longitudinal axis of the flow channel walls between the two points.

In this document, the expression “distance along the normal vector” is generally understood to mean that the distance between two points in three-dimensional space is ascertained in such a way that, in a first computation step, a connecting vector between the two points is calculated by forming the difference between the two points. Subsequently, in a second computation step, the scalar product is formed with the already computed connecting vector and the normal vector. The magnitude of the scalar product thus calculated constitutes the distance along the normal vector between the two points.

Thus, in an illustrative case, the distance along the normal vector of the inlet area between the geometric centroid of the baffle and the geometric centroid of the inlet area is ascertained in the manner that follows. In a first computation step, a connecting vector is calculated between the geometric centroid of the baffle and the geometric centroid of the inlet area by forming the difference between the two points. Subsequently, in a second computation step, the scalar product is formed with the already computed connecting vector and the normal vector of the inlet area. The magnitude of the scalar product thus calculated constitutes the distance along the normal vector of the inlet area between the geometric centroid of the baffle and the geometric centroid of the inlet area.

If the normal vector of the inlet area does not essentially correspond to the main flow direction of the gas mixture flow into the desublimer that arises during the loading process, the distance along the main flow direction is preferable.

In this document, the expression “loading process” is generally understood to mean a process cycle during the operating of a desublimer in which the desublimer is operated until attainment of a predetermined loading of a desublimed gas component or multiple desublimed gas components on the flow channel walls of the desublimation zone. The loading here should be considered to mean the deposited mass of a desublimed gas component or of multiple desublimed gas components on the flow channel walls.

In this document, the term “loading capacity” is generally understood to mean the total mass of desublimed gas component(s) that is desublimed on the flow channel walls during a loading process before the pressure drop between the inlet and outlet of the desublimer exceeds a predetermined value and/or before a predetermined duration is attained as loading time.

In this document, the term “melting process” is generally understood to mean a process cycle during the operating of a desublimer in which the desublimer has reached its loading capacity and, subsequently, the desublimed gas component(s) melt(s) as a result of heating of the flow channel walls and can flow out of the desublimer through, for example, an outlet port at the base of the desublimer. In general, during the melting process, the gas mixture flow into the desublimer is stopped. Typically, the melting process is also referred to as regeneration process.

In this document, the term “recooling process” is generally understood to mean an optional process cycle during the operating of a desublimer in which the flow channel walls of the desublimation zone are cooled after the desublimed gas component(s) has/have been removed from the desublimer. Typically, the recooling process in conjunction with the upstream melting process is also referred to as regeneration process.

In this document, the term “baffle” is generally understood to mean a component which, during the loading process, deflects a gas mixture flowing in from the inlet and distributes it in the gas inlet distributor space such that the gas mixture flows in very uniform distribution through the flow channels of the desublimation zone. In this context, the deflection of the gas mixture flow has the effect, for example, of a local significant change in the magnitudes of the flow rates and in the directions of the flow rates of the gas mixture flow.

In this document, the expression “face area” is generally understood to mean an area that faces a fluid and hence a flow pressure is active in the direction of the face.

In this document, the expression “the face area of the baffle projected onto the plane of the inlet area” is generally understood to mean the area that lies on the plane of the inlet area via the projection of the face area of the baffle. The inlet area is thus part of the plane. In addition, the projection is at right angles to the plane of the inlet area.

In this document, the expression “free gas passage area between the baffle and the desublimation zone” is generally understood to mean an area between the baffle and the desublimation zone through which a fluid can flow unhindered. In this context, the free gas passage area extends over the entire width of the desublimer, wherein the free gas passage area is bounded by the region between the baffle and the desublimation zone, and this boundary extends over the entire width of the free gas passage area.

In this document, the expression “an essentially rectangular design” is generally understood to mean a rectangular design that can also have rounded corners. In addition, the internal angle in the respective corner of the rectangle may vary by up to 10° from the ideal internal angle of 90°, provided of course that the sum total of the internal angle of all corners is indeed 360°. Furthermore, the expression “an essentially rectangular design” may also be understood to mean a regular or irregular polygon, in which case the corners of the polygon may also be rounded. Moreover, the expression “an essentially rectangular design” may also be understood to mean an ellipse or rectangle with an archway disposed thereon.

In this document, the term “static mixer” is generally understood to mean a mixer having multiple elements, by way of example multiple impingement plates, that are at a particular angle to one another, 90° by way of example. In principle, the mixer may comprise flat and/or curved elements. For example, the static mixer may consist of one or more crossbeam elements.

In a preferred configuration of the desublimer of the invention, the desublimation zone is arranged between the gas inlet distributor space and the gas outlet space in such a way that the gas inlet distributor space is spaced apart from the gas outlet space by the desublimation zone. The gas mixture may flow solely through the flow channels of the desublimation zone from the gas inlet distributor space to the gas outlet space or, in the case of reverse flow, from the gas outlet space to the gas inlet distributor space.

This gives rise to the advantage that in no case can there exist a bypass from the gas inlet distributor space to the gas outlet space. Although a bypass would always guarantee that the gas mixture flows through the desublimer during the loading process, a controllable valve in the bypass would be required, which could itself become blocked during the loading process by the at least one gas component to be desublimed.

In a preferred configuration of the desublimer of the invention, in the case of multiple baffles there is a distance in each case between the geometric centroids of respectively adjacent baffles within a range from 0.01*L to 0.5*L, preferably within a range from 0.05*L to 0.33*L, where L corresponds to the length of the longitudinal axis of the gas inlet distributor space and this respective distance is measured along the normal vector of the inlet area. This gives the advantage that, during the loading process, in the case of multiple baffles, the gas mixture can flow more uniformly through the flow channels of the desublimation zone.

In a further embodiment of the above-preferred configuration of the desublimer of the invention, the distance between the adjacent baffles is equal. This gives rise to the advantage that, during the loading process, in the case of multiple baffles, the gas mixture can flow more uniformly through the flow channels of the desublimation zone.

In a preferred configuration of the desublimer of the invention, there is a distance between the desublimation zone and the first baffle or, when there are multiple baffles, a distance in each case between the desublimation zone and the respective baffle, of at least 0.5*D. This gives the advantage that, during the loading process, the gas mixture in the proximity of the respective baffle can flow into the flow channels of the desublimation zone with less of an excessive velocity.

In a preferred configuration of the desublimer of the invention, at least the first baffle has a width within a range from 1*D to the maximum width at which the at least one baffle extends as far as the two opposite housing walls of the desublimer. This gives the advantage that, during the loading process, more uniform flow of the gas mixture is possible through the flow channels of the desublimation zone over a broader region or even over the entire width of the desublimation zone.

In a preferred configuration of the desublimer of the invention, at least the first baffle is movable both before the loading process and during the loading process. In particular, at least the first baffle may also be tilted or moved. Alternatively, at least the first baffle may also be at a fixed location, such that it cannot move during the loading process. This gives the advantage that, during the loading process, the corresponding baffle, depending on the given flow conditions, can be adapted in terms of its alignment and/or its position.

In a preferred configuration of the desublimer of the invention, at least the first baffle is heated during the loading process in order that no gas components to be desublimed and no other fluids can be desublimed on the baffle. In particular, at least the first baffle may have a twin wall, through the internal cavity of which a heating medium can flow. This gives the advantage that the at least one gas component to be desublimed can desublime only slightly, if at all, on the corresponding baffle.

In a preferred configuration of the desublimer of the invention, the desublimer has a horizontal longitudinal axis oriented at right angles to the longitudinal axis of the flow channels of the desublimation zone, and the gas inlet distributor space is disposed above the desublimation zone. In this context, the longitudinal axis of the flow channels of the desublimation zone is preferably oriented parallel to the vector of gravity.

This gives the advantage that, during the loading process, the cooling of the gas mixture flow that takes place in the flow channels of the desublimation zone results in enhanced flow of the gas mixture in the direction of the gas outlet space through the resulting convection effect.

In a preferred configuration of the desublimer of the invention, at least the first baffle is at a distance between the geometric centroid of the baffle and the geometric centroid of the inlet area within a range from 0 to 2.0*D, preferably within a range from 0 to 0.5*D, where the distance is measured along the longitudinal axis of the flow channels of the desublimation zone and the geometric centroid of the first baffle is preferably beneath the geometric centroid of the inlet area. This gives the advantage that, during the loading process, the baffle(s) can distribute the gas mixture more uniformly through the flow channels of the desublimation zone.

In a preferred configuration of the desublimer of the invention, in the case of multiple baffles, each individual baffle downstream of the first baffle is at a distance between its geometric centroid and the geometric centroid of the baffle directly adjacent thereto in the direction of the inlet within a range from 0 to 1.0*D, preferably within a range from 0 to 0.5*D, where the distance is measured along the longitudinal axis of the flow channels of the desublimation zone. This gives the advantage that, during the loading process, the gas mixture can flow more uniformly through the flow channels of the desublimation zone.

In a preferred configuration of the desublimer of the invention, in the case of multiple baffles, the baffle with the greater distance from the inlet area is disposed at a higher level than those with shorter distance from the inlet area, where the distance from the inlet area is measured along the normal vector of the inlet area.

This results in the advantage that, during the loading process, the gas mixture can flow more uniformly through the flow channels of the desublimation zone.

In a further configuration of the desublimer of the invention, at least the geometric centroid of the first baffle is laterally offset in the horizontal plane from the geometric centroid of the inlet area. In this context, for example, the height of the geometric centroid of the first baffle and the height of the geometric centroid of the inlet area may be the same.

This results in the advantage that, during the loading process, the gas mixture can flow more uniformly through the flow channels of the desublimation zone if there should be a corresponding asymmetric gas flow in the gas inlet distributor space.

In a preferred configuration of the desublimer of the invention, in the case of multiple baffles, the geometric centroid of the baffle with the greatest distance from the inlet area is at a distance between its geometric centroid and the geometric centroid of the inlet area 9 within a range from 0 to 2.0*D, preferably within a range from 0 to 1.0*D, where the distance is measured along the longitudinal axis of the flow channels of the desublimation zone.

This gives the advantage that, during the loading process, the gas mixture can flow more uniformly through the flow channels of the desublimation zone.

If, in the above embodiment, there are more than two baffles, the baffles are preferably arranged in such a way that the respective distance between two adjacent baffles is equal, this distance being measured along the normal vector of the inlet area.

This results in the advantage that, during the loading process, the gas mixture can flow more uniformly through the flow channels of the desublimation zone.

In a preferred configuration of the desublimer of the invention, a free gas passage area present between the desublimation zone and the first baffle or, in the case of multiple baffles, between the desublimation zone and the respective baffle, relative to the inlet area, is greater than 0.75, preferably greater than 1.0. This gives the advantage that, during the loading process, the gas mixture in the proximity of the respective baffle can flow into the flow channels of the desublimation zone with less of an excessive velocity.

In a preferred configuration of the desublimer of the invention, the face area of the first baffle projected at right angles onto the plane of the inlet area or, in the case of multiple baffles, the face area of a respective baffle projected at right angles onto the plane of the inlet area, relative to the inlet area, is greater than 1. This results in the advantage that, during the loading process, the gas mixture can flow more uniformly through the flow channels of the desublimation zone.

In a preferred configuration of the desublimer of the invention, at least the first baffle has a ratio between its longest side and its shortest side within a range from 1 to 100, preferably within a range from 1 to 10. This gives the advantage that, during the loading process, the gas mixture can flow more uniformly through the flow channels of the desublimation zone.

In a preferred configuration of the desublimer of the invention, the first baffle or, in the case of multiple baffles, the respective baffle is a static mixer or an impingement plate, preferably an impingement plate with an essentially rectangular design. This gives the advantage that, during the loading process, the gas mixture can flow more uniformly through the flow channels of the desublimation zone.

In a preferred configuration of the desublimer of the invention, at least the first baffle takes the form of a static mixer composed of multiple crossbeam elements, where each individual crossbeam element has two elements, and at least the first baffle is composed of at least two elements, preferably of four to sixteen elements, more preferably of six elements, where the adjacent element is disposed in relation to the respective element with an internal angle directed toward the inlet area within a range from 60 to 120 degrees, preferably within a range from 85 to 95 degrees, more preferably within a range from 89 degrees to 91 degrees. For example, the internal angle directed toward the inlet area may be 90 degrees.

Preferably, the above-described internal angle between the respective elements may be varied before or during the loading process.

This gives the advantage that, during the loading process, the gas mixture can flow more uniformly through the flow channels of the desublimation zone.

In a preferred configuration of the desublimer of the invention, at least the first baffle has a normal vector geometrically averaged over its surfaces facing the inlet, and the internal angle formed by the geometrically averaged normal vector and the normal vector of the inlet area in the direction out of the desublimer is within a range from −60 to 60 degrees, preferably within a range from −45 to 45 degrees, more preferably within a range from −15 to 15 degrees. In the particular case that the corresponding baffle is a static mixer, the static mixer may be composed of multiple crossbeam elements. The geometrically averaged normal vector in this case corresponds to the angle bisector of a crossbeam element directed toward the inlet area. Preferably, the above-described internal angle may be varied before or during the loading process. This results in the advantage that, during the loading process, the gas mixture can flow more uniformly through the flow channels of the desublimation zone.

In a preferred configuration of the desublimer of the invention, the flow channel walls are defined by the outer walls of a tube bundle, a fin tube, a fin tube bundle, a lamellar body, a honeycomb body and/or a plate body. This gives the advantage that, during the loading process, the at least one gas component to be desublimed is desublimed efficiently on the flow channel walls of the desublimation zone, and that the pressure drop across the desublimation zone during the loading process is minimized.

In a preferred configuration of the desublimer of the invention, the desublimer has a length of 7.240 m, a width of 2.850 m, a height of 4.560 m, and a circular inlet area having a diameter of 0.79 m. The desublimer comprises four static mixers as baffles. Each static mixer is composed of three crossbeam elements, with each individual crossbeam element having two elements, and the adjacent element being arranged in relation to the respective element with an internal angle of 90 degrees directed toward the inlet area. The respective element of the crossbeam has a length of 1.130 m, a width of 0.20 m, and a thickness of 0.005 m. Thus, the composition of the individual elements results in a total width for each static mixer of 1.200 m. Each static mixer has a normal vector geometrically averaged over its surfaces facing the inlet. The respective geometrically averaged normal vector in this case corresponds to the angle bisector of a crossbeam element directed toward the inlet area. Each static mixer has an internal angle that arises from the geometrically averaged normal vector and the normal vector of the inlet area in the direction out of the desublimer. For all static mixers, the internal angle is 0 degrees. The geometric centroid of the first baffle is at a distance from the geometric centroid of the inlet area of 1.36 m, where the distance is measured along the normal vector of the inlet area. The respective distance between the geometric centroids of respectively adjacent baffles is 1.4 m, where the respective distance is measured along the normal vector of the inlet area. The baffles present each have a distance between the desublimation zone and the respective baffle of 0.284 m. The respective distance between the geometric centroid of the respective baffle and the geometric centroid of the inlet area is 0.000 m, where the respective distance is measured along the longitudinal axis of the flow channels of the desublimation zone.

The invention further provides a method of operating a desublimer of the invention.

In the method of the invention for operating a desublimer of the invention, during the loading process, the gas mixture flow comprising at least one gas component to be desublimed flows in at the inlet with a mass flow rate of at least 0.01 kg/s, with a temperature within a range from above the desublimation temperature at the given pressure to 300° C. above the desublimation temperature of the at least one gas component to be desublimed at the given pressure, and with an absolute pressure within a range from 0.1 to 10.00 bar, preferably within a range from 0.5 to 1.5 bar, more preferably within a range from 1.05 to 1.10 bar. The flow channel walls of the desublimation zone are cooled to a temperature within a range from 150° C. below the desublimation temperature at the given pressure to 1° C. below the desublimation temperature at the given pressure. The at least one gas component to be desublimed in the gas mixture flow is desublimed at least partly within the desublimer. Preferably, the at least one gas component to be desublimed is desublimed within a range from 10% to 100% by weight, based on the at least one gas component to be desublimed in the gas mixture flow that flows in at the inlet. More preferably, the at least one component to be desublimed is desublimed within a range from 50% to 100% by weight, based on the at least one gas component to be desublimed in the gas mixture flow that flows in at the inlet. If there are multiple gas components to be desublimed in the gas mixture flow, the above-specified ranges relate to the respective gas component to be desublimed.

This results in the advantage that, during the loading process, the at least one gas component to be desublimed is desublimed efficiently on the flow channel walls of the desublimation zone, and that the pressure drop across the desublimation zone during the loading process is minimized. Moreover, the gas mixture also flows more uniformly through the flow channels of the desublimation zone.

In a preferred configuration of the method of the invention for operating a desublimer of the invention, during the loading process, the pressure drop between the inlet and the outlet of the desublimer is not more than 80 mbar, preferably not more than 40 mbar, more preferably not more than 20 mbar. This gives the advantage that, in the case of operation of the loading process at maximum load, the pressure drop does not become too great. If the pressure drop should become too great, the mass flow rate of the gas mixture flow at the inlet could be reduced. In that case, an auxiliary pump could be used in order to be able to achieve the desired mass flow rate of the gas mixture flow at the inlet. However, this is at the risk of the pump becoming blocked by the at least one gas component to be desublimed during operation and hence having to be shut down.

In a preferred configuration of the method of the invention for operating a desublimer of the invention, the pressure drop during the loading process which is caused by the first baffle or, in the case of multiple baffles, by all the baffles present, relative to the pressure drop that arises between the inlet and the outlet of the desublimer, is less than 0.1, preferably less than 0.01. This results in the advantage that the baffle(s) do(es) not make a significant contribution to the pressure drop that arises between the inlet and the outlet of the desublimer. The pressure drop across the baffles is thus small and negligible.

In a preferred configuration of the method of the invention for operating a desublimer of the invention, after the attainment of a predetermined loading of the at least one desublimed gas component on the flow channel walls of the desublimer or after the attainment of a predetermined loading time, a melting process takes place, which comprises the following steps:
shutting down the supply of the gas mixture flow into the desublimer,
heating the flow channel walls of the desublimation zone to a temperature within a range from the desublimation temperature at the given pressure to 300° C. above the desublimation temperature of the at least one gas component to be desublimed at the given pressure,
melting the at least one desublimed gas component in the desublimer to obtain a melt, and
removing the melt from the desublimer, preferably effecting the removal through an outlet port in the housing wall of the gas outlet space.

This gives the advantage that the melting process proceeds efficiently. For example, there is no need to scrape the desublimed gas component(s) off the flow channel walls of the desublimation zone.

In a preferred configuration of the method of the invention for operating a desublimer of the invention, after the melt has been removed from the desublimer, a recooling process takes place, in which the flow channel walls of the desublimation zone are cooled to a temperature within a range from 150° C. below the desublimation temperature at the given pressure to 1° C. below the desublimation temperature at the given pressure. This gives the advantage that, prior to the loading process, the flow channels of the desublimation zone are already at the required temperature for desublimation. Thus, right at the start of the loading process, the at least one gas component to be desublimed is removed efficiently from the gas mixture flow.

In a preferred configuration of the method of the invention for operating a desublimer of the invention, the at least one gas component to be desublimed comprises predominantly phthalic anhydride in its mass fraction, preferably solely phthalic anhydride.

In a preferred configuration of the method of the invention for operating a desublimer of the invention, the concentration of the at least one gas component to be desublimed in the gas mixture flow at the inlet is within a range from 0.001% to 50% by weight, preferably within a range from 0.1% to 10% by weight.

This results in the advantage that the at least one gas component to be desublimed is removed efficiently from the gas mixture flow.

The invention will be elucidated in detail hereinafter with reference to the drawings. The drawings should be considered to be schematic diagrams. They do not constitute a limitation of the invention, for example with regard to specific dimensions or design variants. The figures show:

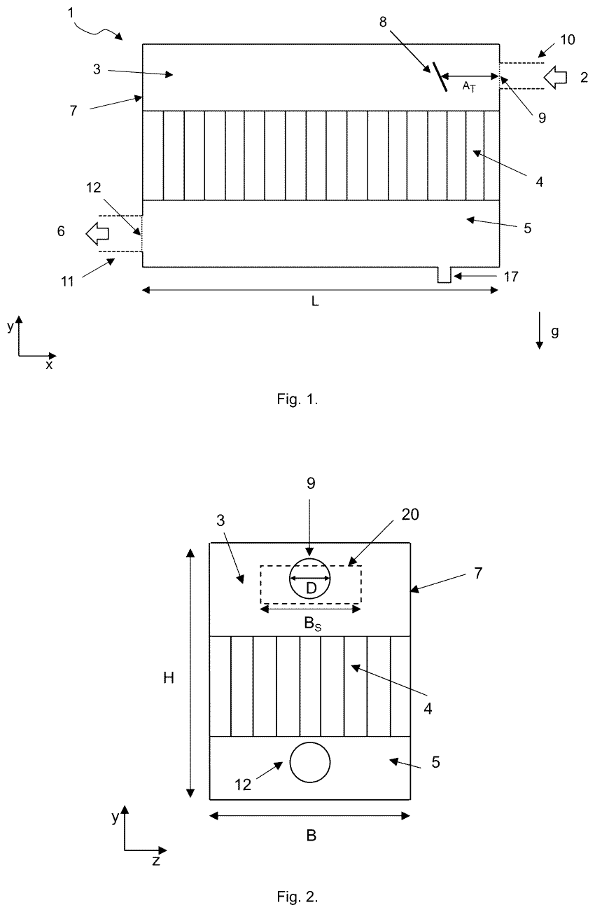

FIG. 1: A drawing of a first illustrative embodiment of a desublimer of the invention in longitudinal section.

FIG. 2: A drawing of the first illustrative embodiment of a desublimer of the invention according to FIG. 1 in cross section.

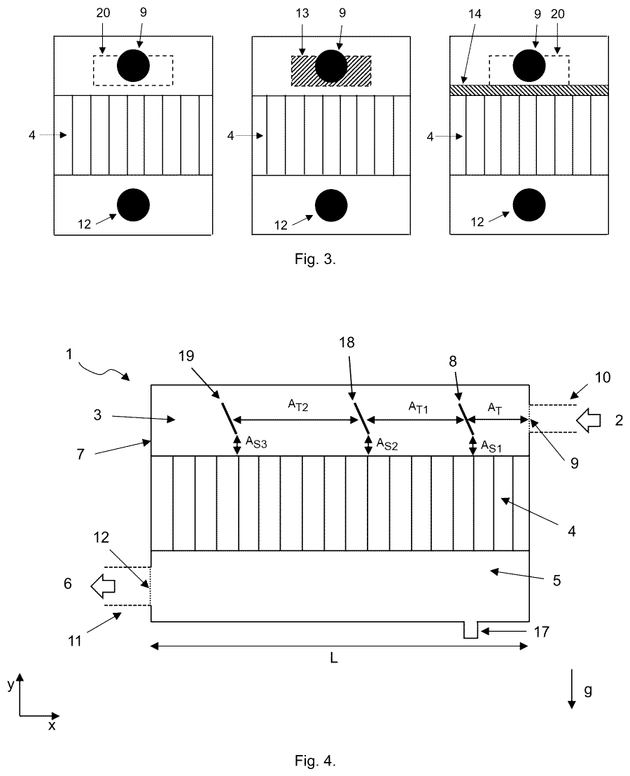

FIG. 3: A drawing of the first illustrative embodiment of a desublimer of the invention according to FIG. 1 in cross section, showing not only the inlet area but also the face area of the baffle projected onto the plane and the free gas passage area.

FIG. 4: A drawing of a second illustrative embodiment of a desublimer of the invention in longitudinal section.

FIG. 5: A drawing of a third illustrative embodiment of a desublimer of the invention in longitudinal section.

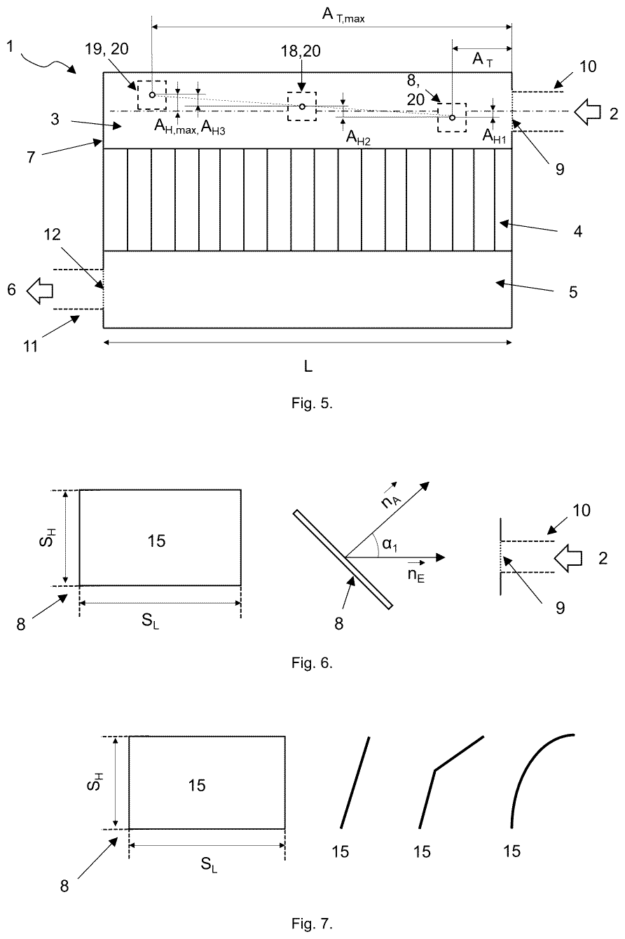

FIG. 6: A drawing of a first illustrative embodiment of a baffle of the invention, having a rectangular and flat design.

FIG. 7: A drawing of a second illustrative embodiment of a baffle of the invention, having a rectangular and curved design.

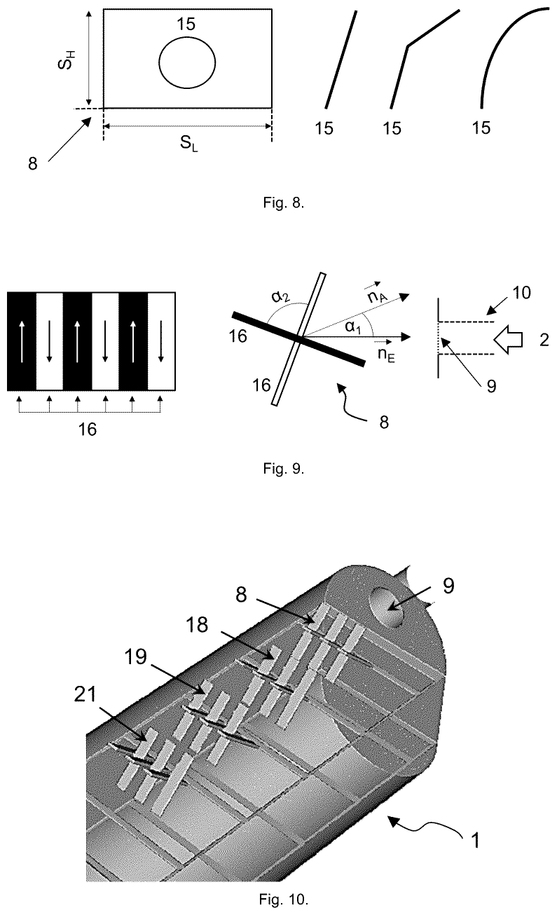

FIG. 8: A drawing of a third illustrative embodiment of a baffle of the invention, having a rectangular and curved design, where the design has a hole.

FIG. 9: A drawing of a fourth illustrative embodiment of a baffle of the invention, wherein at least the first baffle is a static mixer.

FIG. 10: A perspective view of a fourth illustrative embodiment of a desublimer of the invention, wherein there are four static mixers as respective baffles.

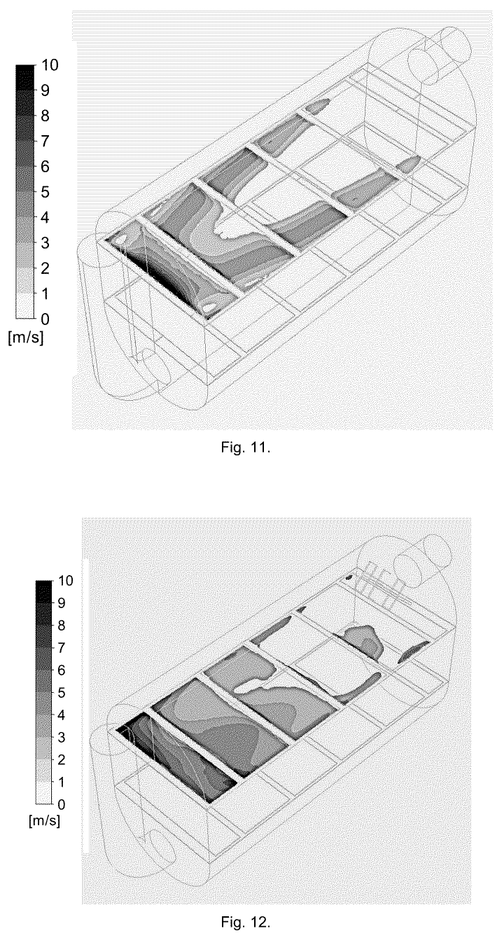

FIG. 11: A perspective view of a first comparative example of a desublimer without a baffle, showing the velocities of the gas mixture flow in the direction of the longitudinal axis of the flow channels in the area shown at the start of the loading process. The area shown here is in the uppermost surface of the desublimation zone.

FIG. 12: A perspective view of a fifth illustrative embodiment of the desublimer of the invention with a static mixer as baffle of the invention, showing the velocities of the gas mixture flow in the direction of the longitudinal axis of the flow channels in the area shown at the start of the loading process. The area shown here is in the uppermost surface of the desublimation zone.

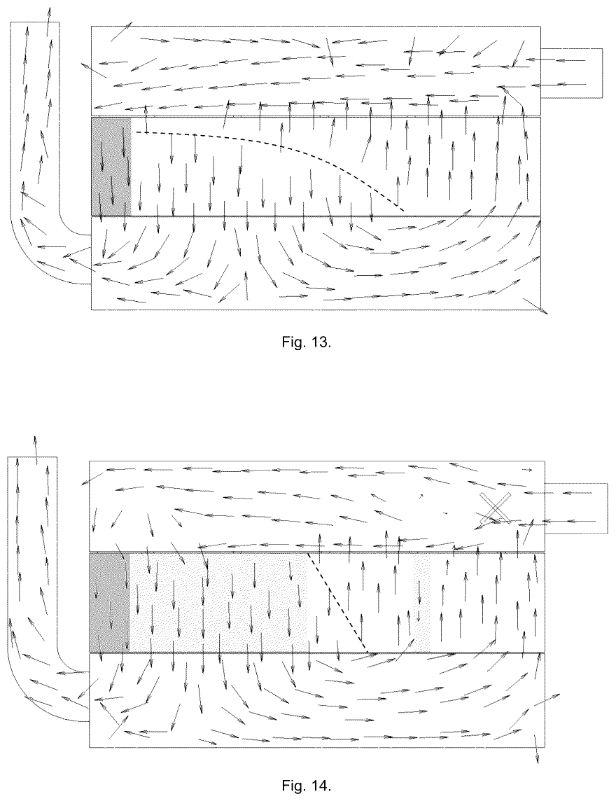

FIG. 13: A vector plot of the velocities of the gas mixture flow at the start of the loading process within a desublimer according to FIG. 11, which does not have a baffle, showing the vector plot in the cross section of the longitudinal desublimer section.

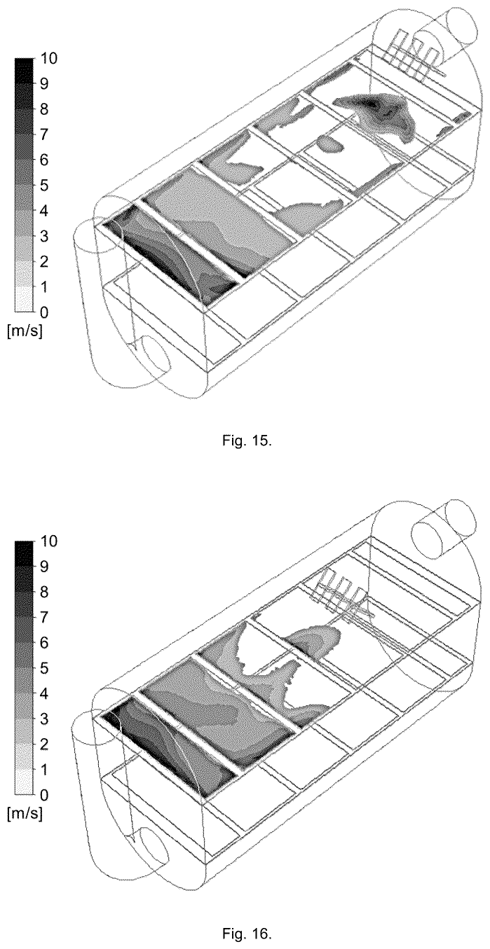

FIG. 14: A vector plot of the velocities of the gas mixture flow at the start of the loading process in the fifth illustrative embodiment of the desublimer of the invention according to FIG. 12, which has a static mixer as baffle of the invention, showing the vector plot in the cross section of the longitudinal desublimer section.

FIG. 15: A perspective view of a sixth illustrative embodiment of the desublimer of the invention with a static mixer as baffle of the invention, showing the velocities of the gas mixture flow in the direction of the longitudinal axis of the flow channels in the area shown at the start of the loading process. The area shown here is in the uppermost surface of the desublimation zone.

FIG. 16: A perspective view of a seventh illustrative embodiment of the desublimer of the invention with a static mixer as baffle of the invention, showing the velocities of the gas mixture flow in the direction of the longitudinal axis of the flow channels in the area shown at the start of the loading process. The area shown here is in the uppermost surface of the desublimation zone.

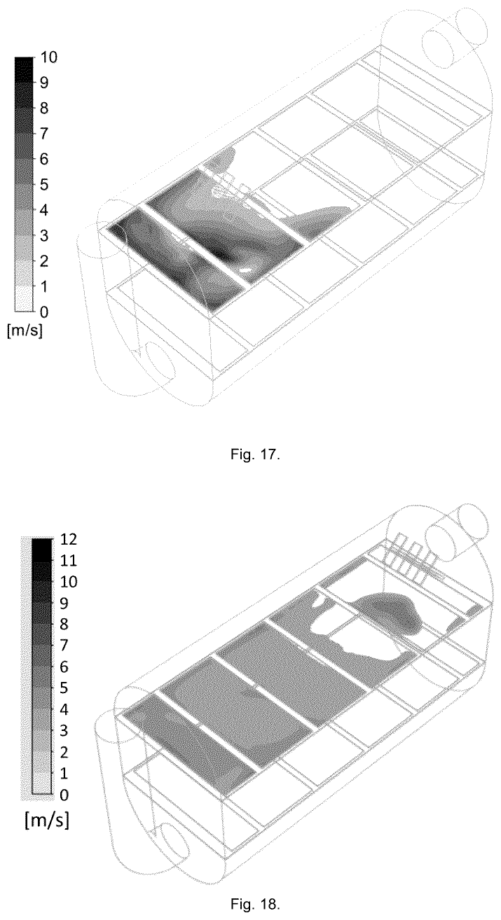

FIG. 17: A perspective view of an eighth illustrative embodiment of the desublimer of the invention with a static mixer as baffle of the invention, showing the velocities of the gas mixture flow in the direction of the longitudinal axis of the flow channels in the area shown at the start of the loading process. The area shown here is in the uppermost surface of the desublimation zone.

FIG. 18: A perspective view of a ninth illustrative embodiment of the desublimer of the invention with a static mixer as baffle of the invention, showing the velocities of the gas mixture flow in the direction of the longitudinal axis of the flow channels in the area shown at the start of the loading process. The area shown here is in the uppermost surface of the desublimation zone.

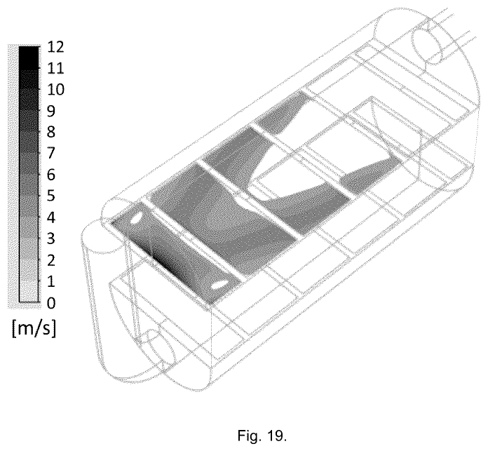

FIG. 19: A perspective view of a second comparative example of a desublimer without a baffle, showing the velocities of the gas mixture flow in the direction of the longitudinal axis of the flow channels in the area shown at the start of the loading process. The area shown here is in the uppermost surface of the desublimation zone.

### LIST OF REFERENCE NUMBERS USED

1 desublimer
2 inlet
3 gas inlet distributor space
4 desublimation zone
5 gas outlet space
6 outlet
7 housing wall
8 baffle
9 inlet area
10 inlet port
11 outlet port
12 outlet area
13 projected face area of the baffle in the plane of the inlet area
14 free gas passage area between the baffle and the desublimation zone
15 curved or flat impingement plate with or without holes
16 curved or flat elements of a mixer with or without quenchers
17 further outlet port with an outflow valve
18 second baffle
19 third baffle
20 boundary frame of a baffle
21 fourth baffle
α1 angle between the negative normal vector n_{E} of the inlet area and the geometrically averaged normal vector n_{A}
α2 angle between two adjacent elements of a mixer
A_{H1} distance between the geometric centroid of the first baffle and the geometric centroid of the inlet area, where the distance is measured along the normal vector n_{E} of the inlet area.
A_{H2} distance between the geometric centroid of the second baffle and the geometric centroid of the inlet area, where the distance is measured along the normal vector n_{E} of the inlet area.
A_{H3} distance between the geometric centroid of the third baffle and the geometric centroid of the inlet area, where the distance is measured along the normal vector n_{E} of the inlet area.
A_{H4} distance between the geometric centroid of the fourth baffle and the geometric centroid of the inlet area, where the distance is measured along the normal vector n_{E} of the inlet area.
A_{H,max} distance between the geometric centroid of the baffle with the greatest distance from the inlet area and the geometric centroid of the inlet area, where the distance A_{H,max} is measured along the longitudinal axis of the flow channels of the desublimation zone.
A_{T} distance between the geometric centroid of a first baffle and the geometric centroid of the inlet area, where the distance is measured along the normal vector n_{E} of the inlet area.
A_{T2} distance between the geometric centroid of a second baffle and the geometric centroid of the first baffle.
A_{T3} distance between the geometric centroid of a third baffle and the geometric centroid of the second baffle.
A_{T4} distance between the geometric centroid of a fourth baffle and the geometric centroid of the third baffle.
A_{T,max} distance between the geometric centroid of the inlet area and the baffle furthest removed from the inlet area.
A_{S1} distance between a first baffle and the desublimation zone
A_{S2} distance between a second baffle and the desublimation zone
A_{S3} distance between a third baffle and the desublimation zone
A_{S4} distance between a fourth baffle and the desublimation zone
B width of the desublimer
B_{S} width of the baffle
D equivalent diameter
g vector of gravity
H height of the desublimer
L length of the desublimer
n_{A} geometrically averaged normal vector of the surfaces of the baffle that face the inlet
n_{E} normal vector of the inlet area
S_{L} length of the baffle
S_{H} height of the baffle

FIG. 1 shows a first illustrative embodiment of an inventive desublimer 1 having a length L in longitudinal section, showing the vector of gravity g by an arrow bottom right in FIG. 1 and showing the xy coordinate system bottom left in FIG. 1.

The desublimer 1 has a horizontal longitudinal axis at right angles to the longitudinal axis of the flow channels of the desublimation zone 4. The desublimer 1 has an inlet 2 with an inlet port 10, through which, during a loading process, a gas mixture flow comprising at least one gas component to be desublimed flows into the gas inlet distributor space 3 of the desublimer 1. For this purpose, an inlet area 9 is correspondingly provided in the housing wall 7, and the housing wall 7 serves as outer boundary of the desublimer 1. A desublimation zone 4 with temperature-controllable flow channel walls spaces the gas inlet distributor space 3 apart from a gas outlet space 5. The desublimation zone is connected to the gas inlet distributor space 3 such that, during the loading process, the gas mixture flow can flow from the gas inlet distributor space 3 to the desublimation zone 4. In addition, the desublimation zone 4 is connected to a gas outlet space 5 such that, during the loading process, the gas mixture flow can flow from the desublimation zone 4 to the gas outlet space 5. An outlet 6 is disposed in the gas outlet space 5, in order that the gas mixture flow can flow out of the desublimer 1 during the loading process. For this purpose, an outlet area 12 is correspondingly provided in the housing wall 7, with an outlet port 11 arranged around the outlet area 12.

The desublimation zone 4 preferably has a volume within a range from 1 to 100 m³.

A baffle 8 is disposed in the gas inlet distributor space 3 such that the gas mixture flow flows more uniformly through the flow channels during the loading process. In this context, the gas mixture should flow through a maximum proportion of the total area of all flow channel walls of the desublimation zone 4 in such a way that the gas mixture flows from the gas inlet distributor space 3 in the direction of the gas outlet space 5.

This provides a maximum area for desublimation.

The maximum flow velocity through the flow channels of the desublimation zone 4 should be as close as possible to the average of the velocities through the flow channels in order to prevent rapid blockage of individual flow channels. Moreover, backflow of the treated gas mixture from the gas outlet space 5 in the direction of the gas inlet distributor space 3 should also be avoided as far as possible in order to be able to avoid any great pressure drop across the desublimation zone 4.

The baffle of the invention in this example is an impingement plate. The geometric centroid of the baffle 8 is at a distance A_{T} from the geometric centroid of the inlet area 9 within a range from 0.5*D to 3.0*D, where D corresponds to the equivalent diameter of a circle of equal area to the inlet area 9 and the distance A_{T} is measured along the normal vector n_{E} of the inlet area 9. Moreover, there is also a further outlet port 17 with an outflow valve, which may, for example, be a sealing closure lid. During the loading process, the outflow valve is in the closed state, which means no gas mixture can flow out of the further outlet port 17. During a melting process, however, the outflow valve is in the open state, which means that the melt produced can flow out of the desublimer. Typically, this further outlet port 17 is at the lowest point of the gas outlet space, such that, as a result of gravity, the melt can flow to the further outlet port 17.

FIG. 2 shows a cross section of the first illustrative embodiment of an inventive desublimer 1 according to FIG. 1, where the desublimer 1 has a height H and a width B. FIG. 2 shows the zy coordinate system bottom left. Shown in cross section are the housing wall 7, the gas inlet distributor space 3, the desublimation zone 4, the gas outlet space 5, the outlet area 12, and the inlet area 9 with a diameter D. In this context, the rectangular boundary frame 20 of the baffle 8 is illustrated by dotted lines. The rectangular boundary frame is defined by the dimensions of the baffle 8 projected at right angles onto the plane of the inlet area.

FIG. 3 shows further details relating to FIG. 2. FIG. 3 again shows, on the left, the inlet area 9 and the rectangular boundary frame 20 of the baffle 8 by dotted lines. Shown in the middle of the drawing, in the background, is the face area 13 of the baffle 8 projected onto the plane of the inlet area 9 and, in the foreground, the inlet area 9. Shown on the right in the drawing is a free gas passage area 14 between the boundary frame 20 of the baffle 8 and the desublimation zone 4.

FIG. 4 shows a second illustrative embodiment of an inventive desublimer 1; by comparison with the first embodiment of the inventive desublimer 1, a further impingement plate as a second baffle 18 and a further impingement plate as a third baffle 19 are disposed in the gas inlet distributor space 3.

A_{T1} here is the distance between the geometric centroid of the second baffle 18 and the geometric centroid of the first baffle 8, A_{T2} is the distance between the geometric centroid of the third baffle 19 and the geometric centroid of the second baffle 18, where these distances are each measured along the normal vector n_{E} of the inlet area 9.

A_{S2} is the distance between the second baffle and the desublimation zone 4, and A_{S3} is the distance between the third baffle and the desublimation zone 4, where these distances are each measured along the longitudinal axis of the flow channels of the desublimation zone 4.

FIG. 5 shows a third illustrative embodiment of an inventive desublimer 1; by comparison with the second embodiment of the inventive desublimer 1, the second baffle 18 and third baffle 19 are each disposed at a different height. In this context, the rectangular boundary frame 20 of the baffle 8 is illustrated by dashed lines, the geometric centroid of the individual baffles 8, 18, 19 by a circle, and the connecting line between the geometric centroids of the individual baffles 8, 18, 19 by a dotted line. The horizontal longitudinal axis of the desublimer 1 is illustrated by a dashed line and runs through the geometric centroid of the inlet area 9.

A_{T,max} here is the distance between the geometric centroid of the furthest-removed baffle 19 and the geometric centroid of the inlet area 9, where the distance A_{T,max} is measured along the normal vector n_{E} of the inlet area 9.

A_{H1} is the distance between the geometric centroid of the first baffle 8 and the geometric centroid of the inlet area 9, A_{H2} is the distance between the geometric centroid of the second baffle 18 and the geometric centroid of the first baffle 8, A_{H3} is the distance between the geometric centroid of the second baffle 18 and the geometric centroid of the third baffle 19, and A_{H,max} is the distance between the geometric centroid of the baffle 19 having the greatest distance A_{T,max} from the inlet area 9 and the geometric centroid of the inlet area 9, where the individual distances A_{H,max}, A_{H1}, A_{H2}, A_{H3} are each measured along the longitudinal axis of the flow channels of the desublimation zone 4.

FIG. 6 shows a first illustrative embodiment of an inventive baffle 8, having an impingement plate 15 in the form of a rectangular and flat design. On the left-hand side of the drawing, the height of the baffle is given as S_{H} and the length of the baffle as S_{L}. Shown in the middle of the drawing is the geometrically averaged normal vector n_{A} of the surface of the baffle 8 facing the inlet 2, and the normal vector n_{E} of the inlet area 9 facing in the negative direction. Additionally presented is the angle α1, where the angle α1 indicates the internal angle between the negative normal vector n_{E} of the inlet area 9 and the geometrically averaged normal vector n_{A}. In this context, the geometrically averaged normal vector n_{A} is ascertained by geometric averaging of the normal vectors of its surfaces facing the inlet 2. Shown on the right-hand side of the drawing are the inlet 2, the inlet area 9, and the inlet port 10.

FIG. 7 shows a second illustrative embodiment of an inventive baffle 8, having an impingement plate 15 in the form of a rectangular and curved or flat design. On the left-hand side of the drawing, the height of the baffle is given as S_{H} and the length of the baffle 8 as S_{L}. Shown on the right-hand side of the drawing are a flat embodiment of the baffle 8 and two illustrative embodiments with possible curvatures for the baffle 8.

FIG. 8 shows a third illustrative embodiment of an inventive baffle 8, having an impingement plate 15 in the form of a rectangular and curved or flat design, where the baffle 8 has a circular hole through which material can flow. On the left-hand side of the drawing, the height of the baffle is given as S_{H} and the length of the baffle 8 as S_{L}. Shown on the right-hand side of the drawing are a flat embodiment of the baffle 8 and two illustrative embodiments with possible curvatures for the baffle 8. In principle, it is possible to use all hole shapes, by way of example a circular, oval or angular hole shape.

In particular, there may also be multiple holes through which material can flow in the impingement plate. The holes through which material can flow may all have a circular or oval shape. Also possible is a mixture of circular and oval holes.

FIG. 9 shows a fourth illustrative embodiment of a baffle 8 of the invention, wherein the baffle is a static mixer. On the left-hand side of the figure, the black rectangles with the arrows therein indicate one particular orientation of a respective element 16 of the mixer, whereas the white rectangles with the arrows therein indicate another particular orientation of a respective element 16 of the mixer. Shown in the middle of the figure is the mixer in cross section, with two adjacent elements 16 of the mixer being apparent. The black element 16 corresponds to the black rectangle on the left-hand side of the drawing, and the white element 16 corresponds to the white rectangle on the left-hand side of the drawing. Additionally shown are the geometrically averaged normal vector n_{A} of the surface of the baffle 8 facing the inlet 2, and the normal vector n_{E} of the inlet area 9 facing in the negative direction. Additionally presented are the two angles α1 and α2, where the angle α1 indicates the internal angle between the normal vector n_{E} of the inlet area 9 in the direction out of the desublimer 1 and the geometrically averaged normal vector n_{A}, and the angle α2 indicates the internal angle between two adjacent elements 16 directed toward the inlet area 9. Shown on the right-hand side of the drawing are the inlet 2, the inlet area 9, and the inlet port 10.

FIG. 10 shows a perspective view of a fourth illustrative embodiment of an inventive desublimer 1, where the desublimer 1 has a length L of 7.240 m, a width B of 2.850 m, a height H of 4.560 m, and a circular inlet area 9 having a diameter of 0.79 m, and comprises four static mixers 8, 18, 19, 21 as baffles.

According to FIG. 9, in FIG. 10, each static mixer 8, 18, 19, 21 is composed of three crossbeam elements, with each individual crossbeam element having two elements 16, and the adjacent element 16 being arranged in relation to the respective element 16 with an internal angle α₂ of 90 degrees directed toward the inlet area 9. The respective element 16 of the crossbeam has a length of 1.130 m, a width of 0.20 m, and a thickness of 0.005 m. Thus, the composition of the individual elements 16 results in a total width for each static mixer 8, 18, 19, 21 of 1.200 m. Each static mixer 8, 18, 19, 21 has a normal vector n_{A} geometrically averaged over its surfaces facing the inlet 2. The respective geometrically averaged normal vector in this case corresponds to the angle bisector of a crossbeam element directed toward the inlet area. Each static mixer 8, 18, 19, 21 has an internal angle α₁ that arises from the geometrically averaged normal vector n_{A} and the normal vector n_{E} of the inlet area 9 in the direction out of the desublimer 1. For all static mixers, the internal angle α₁ is 0 degrees. According to FIG. 1, in FIG. 10, the geometric centroid of the first baffle 8 is at a distance A_{T} from the geometric centroid of the inlet area 9 of 1.36 m, where the distance A_{T} is measured along the normal vector n_{E} of the inlet area 9.

According to FIG. 4, in FIG. 10, the respective distance A_{T1}, A_{T2}, A_{T3} between the geometric centroids of respectively adjacent baffles (8, 18), (18, 19), (19, 21) is 1.4 m, where the respective distance A_{T1}, A_{T2}, A_{T3} is measured along the normal vector n_{E} of the inlet area 9. According to FIG. 4, in FIG. 10, the baffles 8, 18, 19, 21 present are each at a distance A_{S1}, A_{S2}, A_{S3}, A_{S4} between the desublimation zone 4 and the respective baffle 8, 18, 19, 21 of 0.284 m. According to FIG. 5, in FIG. 10, the respective distance A_{H1}, A_{H2}, A_{H3}, A_{H4} between the geometric centroid of the respective baffle 8, 18, 19, 21 and the geometric centroid of the inlet area 9 is 0.000 m, where the respective distance A_{H1}, A_{H2}, A_{H3}, A_{H4} is measured along the longitudinal axis of the flow channels of the desublimation zone 4.

### EXAMPLES

The examples of the process of loading a desublimer that follow are modeled by numerical flow mechanics simulations. The numerical flow mechanics simulations are frequently also referred to as “Computational fluid dynamics (CFD)”.

For this purpose, the ANSYS Fluent software was used, which can be found on the web page https://www.ansys.com/de-de/products/fluids/ansys-fluent (retrieved Aug. 25, 2022). ANSYS Fluent is an extensive simulation software package which is used for modeling, simulation and optimization of flow-related processes, plants and components in industry.

The simulation of the examples that follow is based on a steady-state simulation using the RANS turbulence model. The standard settings of the Fluent Solver, version 22.1, are used here.

### Example 1

A thermodynamic simulation of an inventive embodiment of the method of operating an inventive desublimer 1 according to FIG. 1 was conducted in Fluent.

The length L of the desublimer 1 is 7.24 m, the width B of the desublimer 1 is 2.85 m, the height H of the desublimer 1 is 4.56 m, the diameter D of the circular inlet area 9 is 0.79 m, the diameter of the circular outlet area 12 is 0.79 m, the internal volume of the gas inlet distributor space is 23.8 m³, and the internal volume of the gas outlet space is 24.9 m³.

The ratio between the inlet area of the desublimation zone 4 and the distance between the inlet area and outlet area of the desublimation zone 4 is 13.1 [m²/m].

The desublimation zone 4 has a volume of 32.58 m³. The surface area of all flow channel walls in the desublimation zone 4 is 5000 m². Thus, a cooling area of 5000 m² is available for the loading process, and a heating area of 5000 m² for the melting process.

In the simulation, however, the fin tubes are simplified on account of the computation power required for the purpose such that a porous zone models the four fin tube bundles. The pressure drop across the flow channels of the desublimation zone 4 is thus calculated efficiently. The porous zone is described in detail in chapter 6.2.3 in the ANSYS Fluent User's Guide of Feb. 17, 2016, which is provided by ANSYS, Inc. on its website “https://www.ansys.com/”. In addition, such a porous zone is also shown on page 44 of the website Computational Fluid Dynamics (CFD) of Chemical Processes—Google Books (retrieved Sep. 5, 2022).

In this context, the flow directions of the gas mixture flow within the flow channels that would vary from the longitudinal axis of the flow channels are at least predominantly aligned by a corresponding pressure drop such that these flow directions also point in the direction of the longitudinal axis of the flow channels.

The inventive baffle 8 is designed in the following embodiment:

The inventive baffle 8 is a static mixer composed of three crossbeam elements, with each individual crossbeam element having two elements 16, and the adjacent element 16 being arranged in relation to the respective element 16 with an internal angle α₂ of 90 degrees directed toward the inlet area 9. The respective element 16 of the crossbeam has a length of 0.710 m, a width of 0.200 m, and a thickness of 0.005 m. Thus, the composition of the individual elements 16 results in a total width of the static mixer of 1.200 m.

The baffle 8 has a normal vector n_{A} geometrically averaged over its surfaces facing the inlet 2. The geometrically averaged normal vector in this case corresponds to the angle bisector of a crossbeam element directed toward the inlet area.

An internal angle α₁ that arises from the geometrically averaged normal vector n_{A} and the normal vector n_{E} of the inlet area 9 in the direction out of the desublimer 1 is 0 degrees. The geometric centroid of the baffle 8 is at a distance A_{T} from the geometric centroid of the inlet area 9 of 1.050 m, where the distance A_{T} is measured along the normal vector n_{E} of the inlet area 9.

The resultant distance A_{S1} between the baffle 8 and a desublimation zone 4 is 0.460 m, and the distance A_{H1} between the geometric centroid of the inlet area 9 and the geometric centroid of the baffle 8 is 0.000 m, where the distance A_{H1} is measured along the longitudinal axis of the flow channels of the desublimation zone 4.

The simulation gives the following results:

A gas mixture flow with a mass flow rate of 150 t/h, an absolute pressure of 1.086 bar and a temperature of 178° C. is fed to the desublimer 1 via an inlet 2. The mass flow rate of the gas mixture flow here comprises PA as gas component to be desublimed with a concentration of 8% by weight. Under the present thermodynamic conditions, the density of the gas mixture flow is 4.4 kg/m³, and the dynamic viscosity of the gas mixture flow is 2.5*10⁻⁵ Pa*s. The housing wall is at a temperature of 178° C.

The pressure drop which is caused by the baffle 8 is in the order of magnitude of 1 mbar. The pressure drop between the inlet 2 and the outlet 6 of the desublimer 1 is 17 mbar.

The uniformity achieved in the distribution of the gas mixture flow through the flow channels is assessed using the following results described from the flow simulation:

The desublimation zone 4 is contacted from the gas inlet distributor space 3 over a face area of 9.8 m², with the face area corresponding to the uppermost surface of the desublimation zone 4 according to FIG. 12. In the remaining proportion of the face area, backflow takes place. The maximum velocity of the gas mixture flow through the desublimation zone 4 is 7.6 m/s, and the average velocity of the gas mixture flow through the desublimation zone 4 is 0.46 m/s.

The face area of the desublimation zone 4 is shown in FIG. 12, showing the velocities of the gas mixture flow in the direction of the longitudinal axis of the flow channels at the start of the loading process, and with the face area in the uppermost surface of the desublimation zone 4. The desublimation at the flow channel walls of the desublimation zone 4 takes place at the start of the loading process predominantly in a region on the opposite side of the inlet area 9. Later on in the loading process, the site of desublimation moves in the direction of the inlet area 9. The velocities having velocity vectors oriented in the direction of the main flow direction of the gas mixture flow through the flow channels of the desublimation zone 4 are shown in black when the magnitude of the velocity is not less than 10 m/s. The velocities having velocity vectors oriented in the opposite direction to the main flow direction of the gas mixture flow through the flow channels of the desublimation zone 4 are shown in white when the magnitude of the velocity is greater than 0 m/s.

It is apparent from the comparison of the two FIGS. 11 and 12 that, in the case of an inventive desublimer 1, the gas mixture flows through a larger region of the desublimation zone 4 in the direction of the gas outlet space 5. Moreover, the effect of the inventive baffle 8 is that the back region of the gas inlet distributor space 3 in main flow direction shows velocity directions over the entire width B of the desublimer 1 that are oriented in the direction of the gas outlet space 5. This avoids greater velocities in the flow channels of the desublimation zone 4, and the pressure drop across the desublimation zone 4 is correspondingly smaller. Significant flow through individual flow channels would lead to rapid blockage thereof. In the extreme case, the effect could even be that desublimation can take place only partly at the flow channel walls on account of the high velocities of the gas mixture flow. A baffle 8 reduces excess velocity and backflows caused thereby in adjacent flow channels, as a result of which the aforementioned effects can be avoided or at least partly avoided.

A vector plot of the velocity vectors of the gas mixture flow at the start of the loading process within the inventive desublimer 1 is shown in FIG. 14, showing the vector plot in the cross section of the longitudinal desublimer section. The length of the vectors here is constant and hence independent of the magnitude of the velocity.

It can be seen that, essentially in the left-hand region of the desublimation zone 4, which is indicated by a rectangular frame, the gas mixture flows through the desublimation zone 4 in the direction of the gas outlet space 5. The oblique dashed line in the desublimation zone 4 indicates the changeover point at which the velocity direction through the flow channels of the desublimation zone 4 changes over to the opposite direction. The further the drop in the line, the lesser the extent to which the gas mixture flows through the flow channels of the desublimation zone 4 in the direction of the gas outlet space 5. In the region to the right alongside the oblique dashed line, the gas mixture flows from the gas outlet space 5 through the flow channels of the desublimation zone 4 in the direction of the gas inlet distributor space 3.

It is apparent from the comparison of the two FIGS. 13 and 14 that, in the case of the inventive desublimer 1, the gas mixture flows through a larger region of the desublimation zone 4 in the direction of the gas outlet space 5. This reduces higher velocities in the flow channels of the desublimation zone 4, as a result of which the pressure drop across the desublimation zone 4 during the loading process is correspondingly smaller. In addition, this also reduces backflows from the gas outlet space 5 to the gas inlet distributor space 3.

Excessive flow through individual flow channels would also lead to rapid blockage thereof. In the extreme case, the effect could even be that desublimation can take place only partly at the flow channel walls on account of the high velocities of the gas mixture flow. The baffle 8 reduces excess velocity, as a result of which the aforementioned effects can be avoided or at least partly avoided.

### Example 2

A thermodynamic simulation of an inventive embodiment of the method of operating an inventive desublimer 1 according to FIG. 1 was conducted in Fluent. The only difference between this example 2 and example 1 is the separation A_{T} of the baffle 8. In this example 2, the separation A_{T} is equal to 0.395.

The face area of the desublimation zone 4 is shown in FIG. 15, showing the velocities of the gas mixture flow in the direction of the longitudinal axis of the flow channels at the start of the loading process, and with the face area in the uppermost surface of the desublimation zone 4.

The desublimation at the flow channel walls of the desublimation zone 4 takes place at the start of the loading process predominantly in a region on the opposite side of the inlet area 9. Later on in the loading process, the site of desublimation moves in the direction of the inlet area 9. The velocities having velocity vectors oriented in the direction of the main flow direction of the gas mixture flow through the flow channels of the desublimation zone 4 are shown in black when the magnitude of the velocity is not less than 10 m/s. The velocities having velocity vectors oriented in the opposite direction to the main flow direction of the gas mixture flow through the flow channels of the desublimation zone 4 are shown in white when the magnitude of the velocity is greater than 0 m/s.

It is apparent from the comparison of the two FIGS. 11 and 15 that, in the case of an inventive desublimer 1, the gas mixture flows through a larger region of the desublimation zone 4 in the direction of the gas outlet space 5. Moreover, the effect of the inventive baffle 8 is that the back region of the gas inlet distributor space 3 in main flow direction shows velocity directions over the entire width B of the desublimer 1 that are oriented in the direction of the gas outlet space 5. This avoids greater velocities in the flow channels of the desublimation zone 4, and the pressure drop across the desublimation zone 4 is correspondingly smaller. Significant flow through individual flow channels would lead to rapid blockage thereof. In the extreme case, the effect could even be that desublimation can take place only partly at the flow channel walls on account of the high velocities of the gas mixture flow. A baffle 8 reduces excess velocity and backflows caused thereby in adjacent flow channels, as a result of which the aforementioned effects can be avoided or at least partly avoided.

### Example 3

A thermodynamic simulation of an inventive embodiment of the method of operating an inventive desublimer 1 according to FIG. 1 was conducted in Fluent. The only difference between this example 3 and example 1 is the separation A_{T} of the baffle 8. In this example 3, the separation A_{T} is equal to 2.37.

The face area of the desublimation zone 4 is shown in FIG. 16, showing the velocities of the gas mixture flow in the direction of the longitudinal axis of the flow channels at the start of the loading process, and with the face area in the uppermost surface of the desublimation zone 4.

The desublimation at the flow channel walls of the desublimation zone 4 takes place at the start of the loading process predominantly in a region on the opposite side of the inlet area 9. Later on in the loading process, the site of desublimation moves in the direction of the inlet area 9. The velocities having velocity vectors oriented in the direction of the main flow direction of the gas mixture flow through the flow channels of the desublimation zone 4 are shown in black when the magnitude of the velocity is not less than 10 m/s. The velocities having velocity vectors oriented in the opposite direction to the main flow direction of the gas mixture flow through the flow channels of the desublimation zone 4 are shown in white when the magnitude of the velocity is greater than 0 m/s.

It is apparent from the comparison of the two FIGS. 11 and 16 that the back region of the gas inlet distributor space 3 in main flow direction shows velocity directions over the entire width B of the desublimer 1 that are oriented in the direction of the gas outlet space 5. This avoids greater velocities in the flow channels of the desublimation zone 4, and the pressure drop across the desublimation zone 4 is correspondingly smaller. Significant flow through individual flow channels would lead to rapid blockage thereof. In the extreme case, the effect could even be that desublimation can take place only partly at the flow channel walls on account of the high velocities of the gas mixture flow. A baffle 8 reduces excess velocity and backflows caused thereby in adjacent flow channels, as a result of which the aforementioned effects can be avoided or at least partly avoided.

### Example 4

A thermodynamic simulation of an inventive embodiment of the method of operating an inventive desublimer 1 according to FIG. 1 was conducted in Fluent. The only difference between this example 4 and example 1 is the separation A_{T} of the baffle 8. In this example 3, the separation A_{T} is equal to 5.53.

The face area of the desublimation zone 4 is shown in FIG. 17, showing the velocities of the gas mixture flow in the direction of the longitudinal axis of the flow channels at the start of the loading process, and with the face area in the uppermost surface of the desublimation zone 4.

The desublimation at the flow channel walls of the desublimation zone 4 takes place at the start of the loading process predominantly in a region on the opposite side of the inlet area 9. Later on in the loading process, the site of desublimation moves in the direction of the inlet area 9.

The velocities having velocity vectors oriented in the direction of the main flow direction of the gas mixture flow through the flow channels of the desublimation zone 4 are shown in black when the magnitude of the velocity is not less than 10 m/s. The velocities having velocity vectors oriented in the opposite direction to the main flow direction of the gas mixture flow through the flow channels of the desublimation zone 4 are shown in white when the magnitude of the velocity is greater than 0 m/s.

It is apparent from the comparison of the two FIGS. 11 and 17 that the back region of the gas inlet distributor space 3 in main flow direction shows velocity directions over the entire width B of the desublimer 1 that are oriented in the direction of the gas outlet space 5. This avoids greater velocities in the flow channels of the desublimation zone 4, and the pressure drop across the desublimation zone 4 is correspondingly smaller. Significant flow through individual flow channels would lead to rapid blockage thereof. In the extreme case, the effect could even be that desublimation can take place only partly at the flow channel walls on account of the high velocities of the gas mixture flow. A baffle 8 reduces excess velocity and backflows caused thereby in adjacent flow channels, as a result of which the aforementioned effects can be avoided or at least partly avoided.

### Example 5

A thermodynamic simulation of an inventive embodiment of the method of operating an inventive desublimer 1 according to FIG. 1 was conducted in Fluent. The only differences between this example 5 and example 1 are the physical properties and the mass flow rate of the gas mixture flow. In this example 5, a gas mixture flow with a mass flow rate of 30 t/h, an absolute pressure of 1.086 bar and a temperature of 178° C. is fed to the desublimer 1 via an inlet 2. The mass flow rate of the gas mixture flow here comprises PA as gas component to be desublimed with a concentration of 3% by weight, as a result of which the gas mixture flow has a molar mass of 29.7 g/mol. Under the present thermodynamic conditions, the dynamic viscosity of the gas mixture flow is 2.26*10⁻⁵ Pa*s. The housing wall is at a temperature of 178° C.

The face area of the desublimation zone 4 is shown in FIG. 18, showing the velocities of the gas mixture flow in the direction of the longitudinal axis of the flow channels at the start of the loading process, and with the face area in the uppermost surface of the desublimation zone 4. The face area of 12.5 m² is subject to a flow from the gas inlet distributor space 3 to the gas outlet space 5. In the remaining area proportion of the face area, backflow takes place. The maximum velocity of the gas mixture flow through the desublimation zone 4 is 3.4 m/s, and the average velocity of the gas mixture flow through the desublimation zone 4 is 0.46 m/s. The pressure drop between the inlet 2 and the outlet 6 of the desublimer 1 is 3.3 mbar.

The desublimation at the flow channel walls of the desublimation zone 4 takes place at the start of the loading process predominantly in a region on the opposite side of the inlet area 9. Later on in the loading process, the site of desublimation moves in the direction of the inlet area 9. The velocities having velocity vectors oriented in the direction of the main flow direction of the gas mixture flow through the flow channels of the desublimation zone 4 are shown in black when the magnitude of the velocity is not less than 12 m/s. The velocities having velocity vectors oriented in the opposite direction to the main flow direction of the gas mixture flow through the flow channels of the desublimation zone 4 are shown in white when the magnitude of the velocity is greater than 0 m/s.

It is apparent from the comparison of the two FIGS. 12 and 18 that, in spite of the different physical properties and mass flow rates of the gas mixture flow, the baffle 8 achieves a similar effect in terms of the uniformity of distribution of the gas mixture flow through the flow channels of the desublimation zone 4. In both FIGS. 12 and 18, the loading process takes place predominantly on the opposite side of the inlet area 9, with flow through a significant region in the vicinity of the inlet area 9 in the opposite direction to the main flow direction.

Consequently, excessive velocity and associated backflows in adjacent flow channels are reduced with a baffle 8 even for different physical properties and mass flow rates of the gas mixture flow.

It has been shown that the baffle 8 achieves its effect of better uniformity of distribution through the flow channels of the desublimation zone 4 with different physical properties of the gas mixture flow or at different mass flow rates of the gas mixture flow.

### Comparative Example 1

By comparison with example 1, there is no baffle 8. All the other features of the desublimer 1 and the process parameters for the loading process are the same. Here too, a simulation was conducted with the Fluent software.

The uniformity achieved in the distribution of the gas mixture flow through the individual flow channels is assessed using the following results described from the flow simulation:

The desublimation zone 4 is contacted from the gas inlet distributor space 3 over a face area of 8.6 m², with the face area corresponding to the uppermost surface of the desublimation zone 4. In the remaining proportion of the face area, backflow takes place. The maximum velocity of the gas mixture flow through the desublimation zone 4 is 13.4 m/s, and the average velocity of the gas mixture flow through the desublimation zone 4 is 0.46 m/s.

The face area of the desublimation zone 4 is shown in FIG. 11, showing the velocities of the gas mixture flow at the start of the loading process in the face area shown in the direction of the longitudinal axis of the flow channels, and with the face area in the uppermost surface of the desublimation zone 4.

The desublimation at the flow channel walls of the desublimation zone 4 takes place at the start of the loading process predominantly in a region on the opposite side of the inlet area 9. Later on in the loading process, the site of desublimation moves in the direction of the inlet area 9. The face area has a gradient between the center axis and the housing walls 7, the gradient being defined by the nonuniform velocity distribution. The desublimation takes place particularly in the vicinity of the housing wall 7. In the region of the inlet area 9, barely any desublimation takes place at the start of the loading process.

The velocities having velocity vectors oriented in the direction of the main flow direction of the gas mixture flow through the flow channels of the desublimation zone 4 are shown in black when the magnitude of the velocity is not less than 10 m/s. The velocities having velocity vectors oriented in the opposite direction to the main flow direction of the gas mixture flow through the flow channels of the desublimation zone 4 are shown in white when the magnitude of the velocity is greater than 0 m/s. Values in the intermediate region are represented in accordance with the scale according to FIG. 11.

A vector plot of the velocity vectors of the gas mixture flow at the start of the loading process within the desublimer 1 is shown in FIG. 13, showing the vector plot in the cross section of the longitudinal desublimer section. The length of the vectors here is constant and hence independent of the magnitude of the velocity.

It can be seen that, essentially in the left-hand region of the desublimation zone 4, which is indicated by a rectangular frame, the gas mixture flows completely through the desublimation zone 4 in the direction of the gas outlet space 5. The curved dashed line in the desublimation zone 4 indicates the changeover point at which the velocity direction through the flow channels of the desublimation zone 4 changes over to the opposite direction. The further the drop in the curve, the lesser the extent to which the gas mixture flows through the flow channels of the desublimation zone 4 in the direction of the gas outlet space 5. In the region to the right alongside the curve, the gas mixture flows from the gas outlet space 5 through the flow channels of the desublimation zone 4 in the direction of the gas inlet distributor space 3.

### Comparative Example 2

The only differences in comparative example 2 compared to comparative example 1 are the physical properties and the mass flow rate of the gas mixture flow. Here too, a simulation was conducted with the Fluent software.

In this comparative example 2, a gas mixture flow with a mass flow rate of 30 t/h, an absolute pressure of 1.086 bar and a temperature of 178° C. is fed to the desublimer 1 via an inlet 2. The mass flow rate of the gas mixture flow here comprises PA as gas component to be desublimed with a concentration of 3% by weight, as a result of which the gas mixture flow has a molar mass of 29.7 g/mol. Under the present thermodynamic conditions, the dynamic viscosity of the gas mixture flow is 2.26*10⁻⁵ Pa*s. The housing wall is at a temperature of 178° C.

The uniformity achieved in the distribution of the gas mixture flow through the individual flow channels is assessed using the following results described from the flow simulation:

The desublimation zone 4 is contacted from the gas inlet distributor space 3 over a face area according to FIG. 19, with the face area corresponding to the uppermost surface of the desublimation zone 4. The pressure drop between the inlet 2 and the outlet 6 of the desublimer 1 is 3.2 mbar.

There is a flow through the face area of 8.7 m² from the gas inlet distributor space 3 toward the gas outlet distributor space 5. In the remaining proportion of the face area, backflow takes place. The maximum velocity of the gas mixture flow through the desublimation zone 4 is 11.2 m/s, and the average velocity of the gas mixture flow through the desublimation zone 4 is 0.46 m/s.

The face area of the desublimation zone 4 is shown in FIG. 19, showing the velocities of the gas mixture flow at the start of the loading process in the face area shown in the direction of the longitudinal axis of the flow channels, and with the face area in the uppermost surface of the desublimation zone 4.

The desublimation at the flow channel walls of the desublimation zone 4 takes place at the start of the loading process predominantly in a region on the opposite side of the inlet area 9. Later on in the loading process, the site of desublimation moves in the direction of the inlet area 9.

The face area has a gradient between the center axis and the housing walls 7, the gradient being defined by the nonuniform velocity distribution. The desublimation takes place particularly in the vicinity of the housing wall 7. In the region of the inlet area 9, barely any desublimation takes place at the start of the loading process.

The velocities having velocity vectors oriented in the direction of the main flow direction of the gas mixture flow through the flow channels of the desublimation zone 4 are shown in black when the magnitude of the velocity is not less than 12 m/s. The velocities having velocity vectors oriented in the opposite direction to the main flow direction of the gas mixture flow through the flow channels of the desublimation zone 4 are shown in white when the magnitude of the velocity is greater than 0 m/s. Values in the intermediate region are represented in accordance with the scale according to FIG. 19.

### Conclusion

Example 1 has a face area about 12% greater than the face area in comparative example 1. In addition, example 1 has a maximum velocity about 44% lower than the maximum velocity in comparative example 1.

The greater the contact area, the more flow channels are flowed through from the gas inlet distributor space toward the gas outlet distributor space. In particular, this utilizes a greater proportion of the desublimation area available, represented by the walls of the flow channels. As a result, the flow channel walls are subject to more uniform loading and the corresponding flow channels are blocked less rapidly.

The greater the maximum velocity through the corresponding flow channel, the more pressure drop arises during the loading process across the flow channel.

In particular, in the region of maximum velocity, a very low proportion of the desublimation area available is subject to a very high volume flow rate. Accordingly, there is a locally significant increase in desublimation here, such that these channels are rapidly blocked and can no longer be utilized in the continuation of the loading process. Moreover, in the case of very high volume flow rates, there is an increasing risk that the at least one gas component to be desublimed cannot be fully separated out in this region.

Furthermore, a smaller face area means that the gas mixture flows through only a small region of the desublimation zone 4, and individual flow channels of the desublimation zone 4 become coated more quickly by the desublimation.

Moreover, excessive velocities can cause backflow in adjacent flow channels or enhance existing areas of backflow in adjacent flow channels, which significantly increases the pressure drop across the desublimation zone 4.

Examples 2 to 5 show similar improvements compared to comparative example 1. For instance, example 2 has a contact area about 12% larger than comparative example 1. In addition, example 2 has a maximum velocity about 40% lower than the maximum velocity in comparative example 1.

And although example 3 has a contact area about 7% smaller than comparative example 1, example 3 has a maximum velocity about 32% lower compared to the maximum velocity in comparative example 1.

Moreover, although example 4 has a contact area about 28% smaller than comparative example 1, example 4 has a maximum velocity about 20% lower compared to the maximum velocity in comparative example 1.

In addition, example 5 has a contact area about 43% larger than comparative example 1. In addition, example 5 has a maximum velocity about 74% lower than the maximum velocity in comparative example 1.

Finally, the so-called Uniformity Index Mass Weighted is reported below, which is described in the manual of Fluent Version 2022R1, from page 986. The manual can be found on the webpage https://www.ansys.com/de-de/products/fluids/ansys-fluent (retrieved on Dec. 6, 2023). The aim is for a relatively high uniformity index since flow through the flow channel walls is then more uniform and, consequently, desublimation takes place more uniformly at the flow channel walls and hence the desublimer can be operated for a longer period of time in the loading process, which increases the loading capacity of the desublimer. Moreover, there is a reduced risk of locally excessive velocities, that the at least one gas component to be desublimed is not fully separated out in the desublimation zone and/or that the flow channels in question become impassable within a very short loading time.

This uniformity index, for the examples, is based only on the contact area through which there is flow from the inlet area of the desublimation zone in the direction of the outlet area of desublimation zone.

For instance, example 1 has a higher uniformity index than the uniformity index in comparative example 1 by about 12%, example 2 has a higher uniformity index than the uniformity index in comparative example 1 by about 13%, example 3 has a higher uniformity index than the uniformity index in comparative example 1 by about 15%, example 4 has a higher uniformity index than the uniformity index in comparative example 1 by about 20%, and example 5 has a higher uniformity index than the uniformity index in comparative example 1 by about 7%.

1.-17. (canceled)

18. A discontinuously operated desublimer for removing at least one gas component to be desublimed from a gas mixture flow, comprising
a housing wall as outer boundary,
an inlet in the housing wall for supply of the gas mixture flow to the desublimer,
an outlet in the housing wall for removal of the treated gas mixture flow from the desublimer,
a desublimation zone with temperature-controllable flow channel walls, where the temperature of the flow channel walls is controllable such that, during a loading process, the at least one gas component to be desublimed is desublimed at the flow channel walls, and that, during a subsequent melting process, the at least one gas component desublimed in the loading process melts at the flow channel walls,
a gas inlet distributor space between the inlet and the desublimation zone, and
a gas outlet space between the outlet and the desublimation zone,
wherein
at least a first baffle disposed in the gas inlet distributor space for uniform distribution of the gas mixture flow through the flow channels that result from the flow channel walls in the desublimation zone
has a geometric centroid with a distance (A_{T}) from the geometric centroid of the inlet area within a range from 0.2*D to 10.0*D, where D corresponds to the equivalent diameter of a circle of equal area to the inlet area and the distance (A_{T}) is measured along the normal vector (n_{E}) of the inlet area.

19. The desublimer according to claim 18, wherein, when there are multiple baffles, there is a distance in each case (A_{T1}, A_{T2}) between the geometric centroids of respectively adjacent baffles within a range from 0.01*L to 0.5*L, where L corresponds to the length of the longitudinal axis of the gas inlet distributor space and this respective distance (A_{T1}, A_{T2}) is measured along the normal vector (n_{E}) of the inlet area.

20. The desublimer according to claim 18, wherein there is a distance (A_{S1}) between the desublimation zone and the first baffle or, when there are multiple baffles, a distance in each case (A_{S1}, A_{S2}, A_{S3}) between the desublimation zone and the respective baffle, of at least 0.5*D.

21. The desublimer (1) according to claim 18, wherein at least the first baffle has a width (Bs) within a range from 1*D to the maximum width at which the at least one baffle extends as far as the two opposite housing walls of the desublimer.

22. The desublimer according to claim 18, wherein the desublimer has a horizontal longitudinal axis oriented at right angles to the longitudinal axis of the flow channels of the desublimation zone, and the gas inlet distributor space is disposed above the desublimation zone.

23. The desublimer according to claim 22, wherein at least the first baffle is at a distance (A_{H1}) between the geometric centroid of the baffle and the geometric centroid of the inlet area within a range from 0 to 2.0*D.

24. The desublimer according to claim 22, wherein, in the case of multiple baffles, each individual baffle downstream of the first baffle is at a distance (A_{H2}, A_{H3}) between its geometric centroid and the geometric centroid of the baffle directly adjacent thereto in the direction of the inlet within a range from 0 to 1.0*D, where the distance (A_{H2}, A_{H3}) is measured along the longitudinal axis of the flow channels of the desublimation zone.

25. The desublimer according to claim 22, wherein, in the case of multiple baffles, the baffles with the greater distance from the inlet area are disposed at a higher level than those with shorter distance from the inlet area, where the distance from the inlet area is measured along the normal vector (n_{E}) of the inlet area.

26. The desublimer according to claim 22, wherein, in the case of multiple baffles, the geometric centroid of the baffle with the greatest distance (A_{T,max}) from the inlet area is at a distance (A_{H,max}) between its geometric centroid and the geometric centroid of the inlet area within a range from 0 to 2.0*D.

27. The desublimer according to claim 18, wherein a free gas passage area present between the desublimation zone and the first baffle or, in the case of multiple baffles, between the desublimation zone and the respective baffle, relative to the inlet area, is greater than 0.75.

28. The desublimer according to claim 18, wherein the face area of the first baffle projected at right angles onto the plane of the inlet area or, in the case of multiple baffles, the face area of a respective baffle projected at right angles onto the plane of the inlet area, relative to the inlet area, is greater than 1.

29. The desublimer according to claim 18, wherein the first baffle has a ratio between its longest side (S_{L}) and its shortest side (S_{H}) within a range from 1 to 100.

30. The desublimer according to claim 18, wherein the first baffle or, in the case of multiple baffles, the respective baffle is a static mixer or an impingement plate.

31. The desublimer according to claim 18, wherein the first baffle takes the form of a static mixer composed of multiple crossbeam elements, where each individual crossbeam element has two elements, and the first baffle is composed of at least two elements, where the adjacent element is disposed in relation to the respective element with an internal angle (α₂) directed toward the inlet area within a range from 60 to 120 degrees.

32. The desublimer according to claim 18, wherein at least the first baffle has a normal vector (n_{A}) geometrically averaged over its surfaces facing the inlet, and the internal angle (α₁) formed by the geometrically averaged normal vector (n_{A}) and the normal vector (n_{E}) of the inlet area in the direction from the desublimer is within a range from −60 to 60 degrees.

33. The desublimer according to claim 18, wherein the flow channel walls are defined by the outer walls of a tube bundle, a fin tube, a fin tube bundle, a lamellar body, a honeycomb body and/or a plate body.

34. A method of operating a desublimer according to claim 18, wherein, during the process of loading the desublimer, the gas mixture flow comprising at least one gas component to be desublimed flows in at the inlet with a mass flow rate of at least 0.01 kg/s, with a temperature within a range from above the desublimation temperature at the given pressure to 300° C. above the desublimation temperature of the at least one gas component to be desublimed at the given pressure, and with an absolute pressure within a range from 0.1 to 10.00 bar,
the flow channel walls of the desublimation zone are cooled to a temperature within a range from 150° C. below the desublimation temperature at the given pressure to 1° C. below the desublimation temperature at the given pressure, and
the at least one gas component to be desublimed in the gas mixture flow is at least partly desublimed.
